(19) United States
(12) Patent Application Publication
(10) Pub. No.: US 2019/0242187 A1
(43) Pub. Date: Aug. 8, 2019

(54) SHOCK-ABSORBING GUIDING STRUCTURE FOR EXTENSION TUBE

(71) Applicant: DONGGUAN PRESTIGE SPORTING PRODUCTS CO., LTD., Dongguan (CN)

(72) Inventor: Zhao Zhang, Dongguan (CN)

(21) Appl. No.: 16/328,932

(22) PCT Filed: Jan. 19, 2017
(86) PCT No.: PCT/CN2017/071690

§ 371 Date: Feb. 27, 2019

(30) Foreign Application Priority Data
Aug. 31, 2016 (CN) 201621017313.9

(51) Int. Cl. E06C 7/02

(52) U.S. Cl. CPC E06C 7/02

(57) ABSTRACT

A buffer guiding structure for an extension tube comprises an inner tube, an outer tube, and a buffer member. The inner tube is slidably sleeved into the outer tube. The buffer member is provided at an end surface of one end of the inner tube. An edge of the buffer member engages with an outer edge of the inner tube and abuts against an inner wall of the outer tube, such that when the inner tube extends outwardly, the buffer member is scrolled downwards to reduce a friction force, and when the inner tube retracts inwardly, the buffer member remains slidably abutting against the inner wall of the outer tube, thereby realizing buffer function. The buffer guiding structure for an extension tube has a simple structure and good buffing performance, and can protect hands from being clamped.

### FIELD OF THE INVENTION

The present invention relates to a telescopically extendable and collapsible ladder, and more particularly to a buffer guiding structure for extension tube.

### BACKGROUND OF THE INVENTION

Currently, the existing telescopic ladder includes a plurality of ladder columns and cross bars. The plurality of ladder columns are telescopically assembled and installed, and then the two adjacent ladder columns are locked by a locking mechanism, so that the ladder columns are unfolded and locked. When the existing telescopic ladder is folded, the locking mechanism is unlocked so that an upper ladder column can be sleeved into a lower ladder column. However, when the locking mechanism is unlocked, due to gravity, the upper ladder column may slide downward instantaneously. At this time, if the hand is placed on a cross bar of the lower ladder column or if the hand does not leave a cross bar of the lower ladder column in time, the finger will be pinched. Therefore, the existing telescopic ladder lacks safety and is inconvenient to use.

### SUMMARY OF THE INVENTION

One objective of the present invention is to provide a buffer guiding structure for an extension tube with simple structure, a good buffer effect and an anti-pinch function.

To achieve the above-mentioned objective, the present invention provides a buffer guiding structure for an extension tube including an inner tube, an outer tube, and a buffer piece. Specifically, the inner tube is slidably sleeved into the outer tube, and the buffer piece is provided at an end surface of one end of the inner tube. An edge of the buffer piece engages with an outer edge of the inner tube and abuts against an inner wall of the outer tube, such that the buffer piece is scrolled downwards to reduce a friction force when the inner tube is extended outwardly, and the buffer piece keeps slidably abutting against the inner wall of the outer tube to realize a buffer function when the inner tube is retracted inwardly.

In comparison with the prior art, a buffer piece is provided at an end surface of one end of the inner tube. Accordingly, an edge of the buffer piece abuts against an inner wall of the outer tube, such that the buffer piece is scrolled downwards to reduce a friction force when the inner tube is extended outwardly, and the buffer piece keeps slidably abutting against the inner wall of the outer tube to realize a buffer function when the inner tube is retracted inwardly. The buffer guiding structure for an extension tube has a simple structure and a good buffer effect on a ladder column of the telescopic ladder, and can prevent the telescopic ladder from pinching one's hand when the telescopic ladder is folded.

Preferably, the buffer guiding structure for an extension tube further includes a guiding sleeve fixed to an end surface of the inner tube, and the buffer piece is disposed on the guiding sleeve. The guiding sleeve is arranged to limit the buffer piece on the one hand and to guide the inner tube on the other hand.

Preferably, the buffer piece is fixed to the guiding sleeve by a screw. Therefore, the buffer piece will be fixed, and the edge of the buffer piece can be turned down or not turned, so that the inner tube can be extended or buffered.

Preferably, the guiding sleeve is provided with a mounting position where the buffer piece is placed.

Preferably, the guiding sleeve is provided with a mounting portion having an engaging portion, the inner tube is provided with a through hole, and the mounting portion is extended into the inner tube, so that the engaging portion is engaged with the through hole. The mounting portion is arranged for quickly fixing and easy assembling the guide sleeve to the inner tube.

Specifically, the buffer pieces are fan-shaped; and multiple the buffer pieces are distributed around a central axis of the inner tube.

Preferably, the buffer piece is a silica gel piece.

### BRIEF DESCRIPTION OF THE DRAWINGS

FIG. 1 is a perspective view of a telescopic ladder according to one embodiment of the present invention;

FIG. 2 is a perspective view of a buffer guiding structure for an extension tube according to one embodiment of the present invention; and

FIG. 3 is an exploded view of the buffer guiding structure for an extension tube according to one embodiment of the present invention.

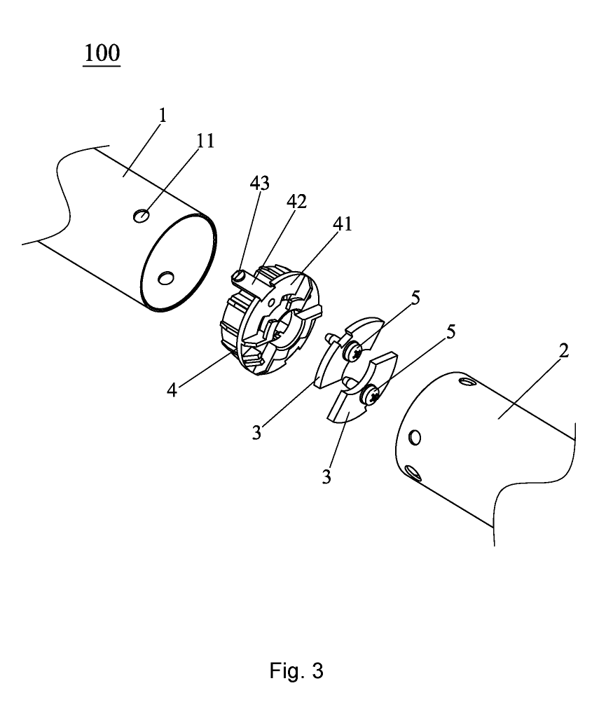

### DETAILED DESCRIPTION OF ILLUSTRATED EMBODIMENTS

A distinct and full description of the technical solution of the present invention will follow by combining with the accompanying drawings.

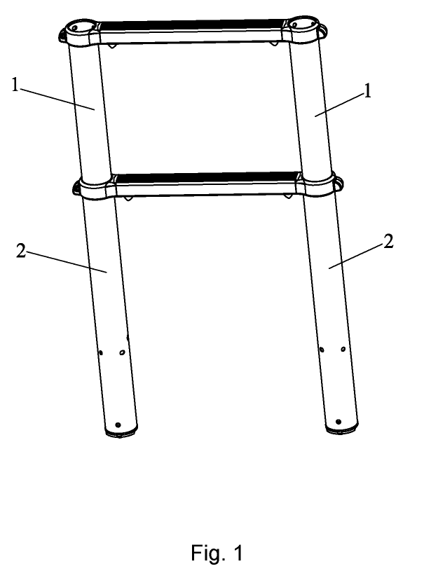

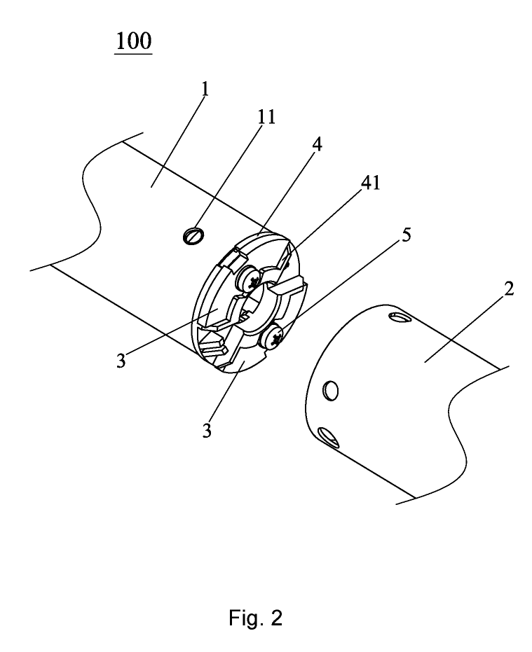

Referring to FIGS. 1 and 2, a buffer guiding structure for an extension tube 100 includes an inner tube 1, an outer tube 2, a buffer piece 3, and a guiding sleeve 4. Specifically, the inner tube 1 is slidably sleeved into the outer tube 2, and the guiding sleeve 4 is provided at an end surface of one end of the inner tube 1. The guiding sleeve 4 is arranged to limit the buffer piece 3 on the one hand and to guide the inner tube 1 on the other hand. More specifically, the buffer piece 3 is disposed on the guiding sleeve 4, an edge of the buffer piece 3 engages with an outer edge of the inner tube 1 and abuts against an inner wall of the outer tube 2, such that the buffer piece 3 is scrolled downwards to reduce a friction force when the inner tube 1 is extended outwardly, and the buffer piece 3 is slidably abutted against the inner wall of the outer tube 2 to realize a buffer function when the inner tube 1 is retracted inwardly.

Specifically, the buffer piece 3 is fixed to the guiding sleeve 4 by a screw 5. Therefore, the buffer piece 3 will be fixed, furthermore, the edge of the buffer piece 3 can be scrolled downwards or not scrolled, so that the inner tube 1 can be extended or buffered. Furthermore, the guiding sleeve 4 is provided with a mounting position 41 where the buffer piece 3 is placed. Preferably, the guiding sleeve 4 is provided with a mounting portion 42, the mounting portion 42 has an engaging portion 43, the inner tube 1 is provided with a through hole 11, and the mounting portion 42 is extended into the inner tube 1, so that the engaging portion 43 is engaged with the through hole 11. The mounting portion 42 is arranged for quickly fixing and easy assembling the guide sleeve 4 to the inner tube 1.

Specifically, the buffer piece 3 is fan-shaped; and multiple the buffer pieces 3 are distributed around a central axis of the inner tube 1. In this embodiment, the number of the buffer piece 3 is two, but not limited to it. Preferably, the buffer piece 3 is a silica gel piece.

In comparison with the prior art, a buffer piece 3 is provided at an end surface of one end of the inner tube 1. Accordingly, an edge of the buffer piece 3 abuts against an inner wall of the outer tube 2, such that the buffer piece 3 is scrolled downwards to reduce a friction force when the inner tube 1 is extended outwardly, and the buffer piece 3 keeps slidably abutting against the inner wall of the outer tube 2 to realize a buffer function when the inner tube 1 is retracted inwardly. The buffer guiding structure for an extension tube has a simple structure and a good buffer effect on a ladder column of the telescopic ladder, and can prevent the telescopic ladder from pinching one's hand when the telescopic ladder is folded.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A buffer guiding structure for an extension tube, comprising an outer tube, an inner tube sleeved into the outer tube, a buffer piece, and a guiding sleeve fixed to an end surface of the inner tube, wherein the buffer piece is disposed on the guiding sleeve, an edge of the buffer piece engages with an outer edge of the inner tube and abuts against an inner wall of the outer tube, such that the buffer piece is scrolled downwards to reduce a friction force when the inner tube is extended outwardly, and the buffer piece keeps slidably abutting against the inner wall of the outer tube to realize a buffer function when the inner tube is retracted inwardly.

2. (canceled)

3. The buffer guiding structure for an extension tube according to claim 1, wherein the buffer piece is fixed to the guiding sleeve by a screw.

4. The buffer guiding structure for an extension tube according to claim 1, wherein the guiding sleeve is provided with a mounting position where the buffer piece is placed.

5. The buffer guiding structure for an extension tube according to claim 1, wherein the guiding sleeve is provided with a mounting portion having an engaging portion, the inner tube is provided with a through hole, and the mounting portion is extended into the inner tube, so that the engaging portion is engaged with the through hole.

6. The buffer guiding structure for an extension tube according to claim 1, wherein the buffer piece is fan-shaped, and multiple buffer pieces are distributed around a central axis of the inner tube.

7. The buffer guiding structure for an extension tube according to claim 1, wherein the buffer piece is a silica gel piece.

8. The buffer guiding structure for an extension tube according to claim 3, wherein the buffer piece is a silica gel piece.

9. The buffer guiding structure for an extension tube according to claim 4, wherein the buffer piece is a silica gel piece.

10. The buffer guiding structure for an extension tube according to claim 5, wherein the buffer piece is a silica gel piece.

11. The buffer guiding structure for an extension tube according to claim 6, wherein the buffer piece is a silica gel piece.

12. The buffer guiding structure for an extension tube according to claim 7, wherein the buffer piece is a silica gel piece.
